(19) United States
(12) Patent Application Publication
(10) Pub. No.: US 2009/0099868 A1
(43) Pub. Date: Apr. 16, 2009

(54) Facilitating a Transaction between a Client and a Life Science Research Service Provider

(75) Inventors: Kevin D. Lustig, Solana Beach, CA (US); Andrew Martin, Woodside, CA (US); Christopher L. Petersen, San Diego, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: The Assay Depot, Inc., San Diego, CA (US)

(21) Appl. No.: 12/245,589

(22) Filed: Oct. 3, 2008

Related U.S. Application Data
(60) Provisional application No. 60/977,634, filed on Oct. 4, 2007.

(51) Int. Cl. G06Q 50/00; G06Q 30/00

(52) U.S. Cl. 705/2; 705/26

(57) ABSTRACT

Disclosed herein are methods of facilitating transactions between clients and life science research service providers.

### CROSS-REFERENCES TO RELATED APPLICATIONS

This application claims priority to U.S. Provisional Patent Application No. 60/977,634, file Oct. 4, 2007, which is herein incorporated by reference in its entirety for all purposes.

### BACKGROUND OF THE INVENTION

Successful life science research service providers and their clients must devote significant time, effort and money to sample management, data management and analysis, accumulating knowledge of publicly accessible standard control samples, web site development, and sales and marketing. Building these essential business functions uses resources that otherwise could be used to develop core research technologies and expand service offerings. Moreover, the absence of these functions often prevents the association of, and subsequent transactions between, life science research providers and their clients.

Therefore, there is a need for companies that can provide these services in an efficient, accurate, and cost effective manner to clients and/or life science research service providers in order to facilitate transactions between clients and life science research service providers. The present invention provides solutions to these and other needs in the art of life sciences.

A reference in this specification to any prior publication (or information derived there from), or to any matter which is known, is not, and should not be taken as an acknowledgement or admission or any form of suggestion that the prior publication (or information derived there from) or known matter forms part of the common general knowledge in the field to which this specification relates.

### SUMMARY OF THE INVENTION

Disclosed herein are methods of facilitating transactions between clients and life science research service providers (also referred to herein as research service providers or service providers). The methods are useful in creating, establishing, and expanding relationships between clients and service providers. The methods are performed by a single facilitator company which typically receives monetary compensation from the life science research service provider and/or the client.

In one aspect, the present invention provides a method of facilitating a transaction between a client and a life science research service provider. The method is performed by a single facilitator company and includes detecting an order on a computer from the client for the life science research service provider to provide a research service on a test sample. The test sample is a chemical test sample or a biological test sample. The facilitator company receives the test sample from the client and processes the test sample to form a readily usable test sample for the life science research service provider. The readily usable test sample is sent to the life science research service provider thereby facilitating the transaction.

In another aspect, a method of facilitating a transaction between a client and a life science research service provider is provided. The method is performed by a single facilitator company and includes providing a selectable internet-based listing of a life science research service. An order is detected on a computer from the client for the life science research service. The facilitator company recommends a control sample based on the order and sends the control sample to the life science research service provider thereby facilitating the transaction.

In another aspect, a method of facilitating a transaction between a client and a life science research service provider is provided. The method is performed by a single facilitator company and includes providing a selectable internet-based listing of a plurality of functional life science objectives, each objective being achieved by performing a plurality of life science research services. At least one of the plurality of life science research services is performed by the life science research service provider. The order is detected on a computer from the client for at least one of the plurality of functional life science objectives. The life science research service provider is notified of the order thereby facilitating the transaction.

In another aspect, a method of facilitating a transaction between a client and a life science research service provider is provided. The method is performed by a single facilitator company and includes detecting an order on a computer from the client for the life science research service provider to provide a life science research service on a test sample. The test sample is a chemical test sample or a biological test sample. The facilitator company receives data from the life science research service provider for the life science research service on the test sample. The data is analyzed and a report is prepared for the client based on the analysis. The report is sent to the client thereby facilitating the transaction.

### BRIEF DESCRIPTION OF THE DRAWINGS

FIG. 1 is an illustration of one embodiment of the present invention: A. the Facilitator company detects orders and receives test samples from clients (e.g., clients in the life sciences industry); B. the facilitator company aggregates test samples from one or more orders for each Life Science Service Provider's service, and converts test samples to a readily useable format; C. the facilitator company receives a single data report from each service provider that contains results for the aggregated test samples from one or more clients; D. the facilitator company processes the aggregate data, prepares a single data report for each client's test sample, and sends a single report to each Client.

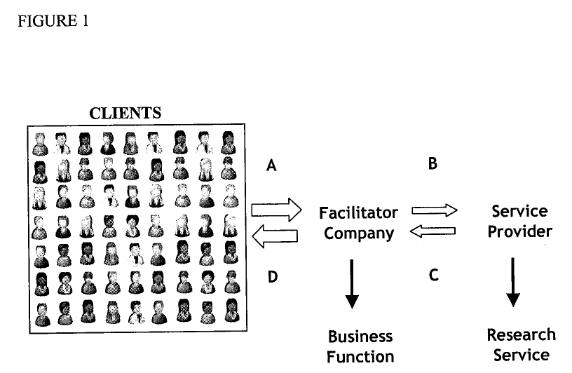

FIG. 2 is an illustration of one embodiment of the present invention: A. the facilitator company detects an order on a computer from the client for a life science research service provider to provide a life science research service on a test sample; B. the facilitator company receives a test sample from the client; C. the facilitator company notifies the service provider that an order has been placed; D. the facilitator company processes the test sample to form a readily usable test sample for the life science research service provider and sends it to the life science research provider; E. the facilitator company receives data from the service provider after the service provider performs the ordered life science research service; and F. the facilitator company analyzes the data, prepares a report for the client based on the analysis, and sends the report to the client.

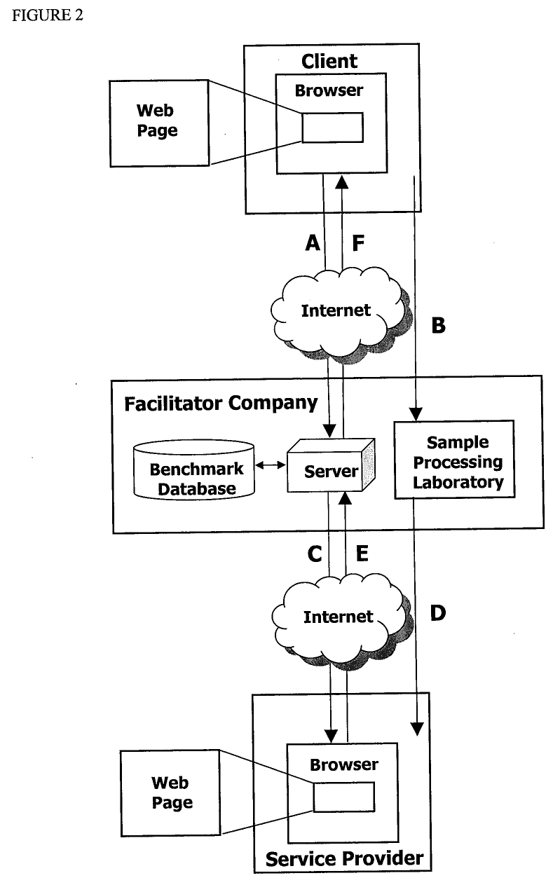

FIG. 3 is an illustration of one embodiment of the present invention illustrating the work flow for one order from one client to one service provider via the facilitator company.

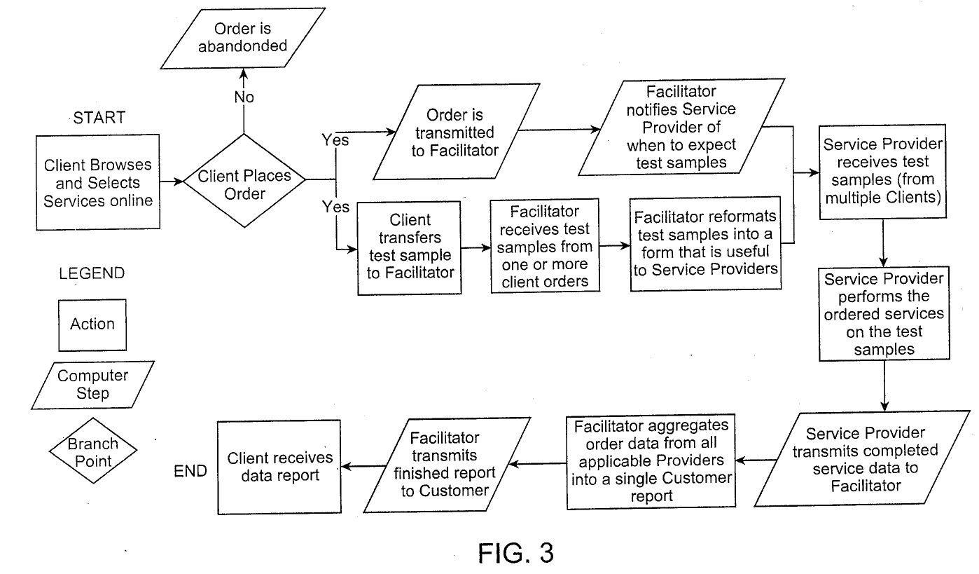

### DETAILED DESCRIPTION OF THE INVENTION

### I. Definitions

The abbreviations used herein have their conventional meaning within the life sciences and computational arts.

“Nucleic acid” refers to deoxyribonucleotides or ribonucleotides and polymers thereof in either single- or double-stranded form. The term encompasses nucleic acids containing known nucleotide analogs or modified backbone residues or linkages, which are synthetic, naturally occurring, and non-naturally occurring, which have similar binding properties as the reference nucleic acid, and which are metabolized in a manner similar to the reference nucleotides. Examples of such analogs include, without limitation, phosphorothioates, phosphoramidates, methyl phosphonates, chiral-methyl phosphonates, 2-O-methyl ribonucleotides, peptide-nucleic acids (PNAs).

The terms “polypeptide,” “peptide” and “protein” are used interchangeably herein to refer to a polymer of amino acid residues. The terms apply to amino acid polymers in which one or more amino acid residue is an artificial chemical mimetic of a corresponding naturally occurring amino acid, as well as to naturally occurring amino acid polymers and non-naturally occurring amino acid polymer.

The term “amino acid” refers to naturally occurring and synthetic amino acids, as well as amino acid analogs and amino acid mimetics that function in a manner similar to the naturally occurring amino acids. Naturally occurring amino acids are those encoded by the genetic code, as well as those amino acids that are later modified, e.g., hydroxyproline, y-carboxyglutamate, and O-phosphoserine. Amino acid analogs refers to compounds that have the same basic chemical structure as a naturally occurring amino acid, i.e., a carbon that is bound to a hydrogen, a carboxyl group, an amino group, and an R group, e.g., homoserine, norleucine, methionine sulfoxide, methionine methyl sulfonium. Such analogs have modified R groups (e.g., norleucine) or modified peptide backbones, but retain the same basic chemical structure as a naturally occurring amino acid. Amino acid mimetics refers to chemical compounds that have a structure that is different from the general chemical structure of an amino acid, but that functions in a manner similar to a naturally occurring amino acid.

“Antibody” refers to a polypeptide comprising a framework region from an immunoglobulin gene or fragments thereof that specifically binds and recognizes an antigen. The recognized immunoglobulin genes include the kappa, lambda, alpha, gamma, delta, epsilon, and mu constant region genes, as well as the myriad immunoglobulin variable region genes. Light chains are classified as either kappa or lambda. Heavy chains are classified as gamma, mu, alpha, delta, or epsilon, which in turn define the immunoglobulin classes, IgG, IgM, IgA, IgD and IgE, respectively.

An exemplary immunoglobulin (antibody) structural unit comprises a tetramer. Each tetramer is composed of two identical pairs of polypeptide chains, each pair having one “light” (about 25 kDa) and one “heavy” chain (about 50-70 kDa). The N-terminus of each chain defines a variable region of about 100 to 110 or more amino acids primarily responsible for antigen recognition. The terms variable light chain (VL) and variable heavy chain (VH) refer to these light and heavy chains respectively.

Antibodies may exist as intact immunoglobulins or as a number of well-characterized fragments produced by digestion with various peptidases. Thus, for example, pepsin digests an antibody below the disulfide linkages in the hinge region to produce F(ab)′2, a dimer of Fab which itself is a light chain joined to VH-CH1 by a disulfide bond. The F(ab)′2 may be reduced under mild conditions to break the disulfide linkage in the hinge region, thereby converting the F(ab)′2 dimer into an Fab′ monomer. The Fab′ monomer is essentially Fab with part of the hinge region (see Fundamental Immunology (Paul ed., 3d ed. 1993). While various antibody fragments are defined in terms of the digestion of an intact antibody, one of skill will appreciate that such fragments may be synthesized de novo either chemically or by using recombinant DNA methodology. Thus, the term antibody, as used herein, also includes antibody fragments either produced by the modification of whole antibodies, or those synthesized de novo using recombinant DNA methodologies (e.g., single chain Fv) or those identified using phage display libraries (see, e.g., McCafferty et al., Nature 348:552-554 (1990)).

For preparation of monoclonal or polyclonal antibodies, any technique known in the art can be used (see, e.g., Kohler & Milstein, Nature 256:495-497 (1975); Kozbor et al., Immunology Today 4: 72 (1983); Cole et al., pp. 77-96 in Monoclonal Antibodies and Cancer Therapy (1985)). Techniques for the production of single chain antibodies (U.S. Pat. No. 4,946,778) can be adapted to produce antibodies to polypeptides of this invention. Also, transgenic mice, or other organisms such as other mammals, may be used to express humanized antibodies. Alternatively, phage display technology can be used to identify antibodies and heteromeric Fab fragments that specifically bind to selected antigens (see, e.g., McCafferty et al., Nature 348:552-554 (1990); Marks et al., Biotechnology 10:779-783 (1992)).

A “drug” is a substance that affects a biological process. Drugs typically are used for treating, curing or preventing disease in human beings or in animals. A drug may also be used for making a medical diagnosis or for restoring, correcting, or modifying physiological functions.

### II. Methods

Methods are disclosed herein of facilitating a transaction between a client and a life science research service provider. The transaction is typically an exchange between the client and a life science research service provider of services, information, funds, or test samples. The exchange may be from the client to the service provider or from the service provider to the client. The exchange is promoted by a facilitator company that acts to assist in bringing about the exchange. For example, the exchange may be an indirect exchange that proceeds through the facilitator company, which performs steps as a service to the service provider and/or client to make possible or smooth the progress of the exchange.

The steps performed by the facilitator company are specifically designed to facilitate transactions within the life sciences field. Thus, a “life science research service provider,” as used herein, refers to a research service provider within the life sciences field. The life sciences field deals with the structure and behavior of living organisms and their components, and includes disciplines relating to, for example, chemistry, biochemistry, biology, pharmacology, toxicology, pharmacy and medicine. A research service provider performs systematic scientific investigations as a service, including scientific development, testing, and evaluation, designed to develop or contribute to the knowledge of a client.

The service provider may provide any appropriate research service within the life sciences field, such as cellular assays (e.g., protein expression assays, cell viability assays or signal transduction pathway assays), in vitro molecular interaction assays (e.g., binding assays, substrate modification assays or phosphorylation assays), molecular property assays (e.g., solubility assays, molecular mass assays and molecular structure assays), pharmacokinetic assays (e.g., protein binding assays, cell permeability assays or metabolic stability assays), pharmacology assays (e.g., animal disease model assays and disease biomarker assays), toxicology assays (e.g., cardiotoxicity assays, genotoxicity assays or multidrug resistance assays), chemistry services (e.g., compound purchasing services, benchmark synthesis services or lead optimization services), and the like.

The life science research provider, facilitator company, and client are separate entities in separate remote locations. In some embodiments, the life science research service provider is a for-profit life science research service provider company, such as a corporation. A for-profit life science research service provider company is a life science research service provider company that performs life science research services for funds for the purpose of profiting from the service, such as a life science research service provider corporation. Examples of a for-profit life science research service provider company include a pharmaceutical company, a diagnostics company, an assay reagent company, an assay technology company, or a biotechnology company.

The life science research service provider may also be a non-profit institutional life science research service provider. A non-profit institutional life science research service provider is a life science research service provider company that performs life science research services for funds for a purpose other than making profits. Examples of non-profit institutional life science research service providers include academic life science research service providers, such as universities and research institutes, as well as publicly funded research laboratories.

The client may be a for-profit company client (e.g., a corporation) or non-profit institutional client. A for-profit company client may be pharmaceutical company, a diagnostic company, a virtual drug discovery company, an environmental analysis company, a cosmetics company, a neutraceutical company or a biotechnology company. A non-profit institutional client may be an academic client (e.g., a university, research institute, or academic life science researchers) or a publicly funded research laboratory.

In some embodiments, the methods are performed with a plurality of clients and/or a plurality of life science research providers. Thus, the methods may be used to bundle together a multitude of clients and service providers to facilitate a plurality of transactions. For example, the methods may be practiced with over 100,000 biotechnology, pharmaceutical and academic life science researcher clients. In certain embodiments, the methods are practiced with a multitude of clients for a single life science research service provider, in which the orders from the multitude of clients are aggregated by the facilitator company for the life science research service provider.

A. Steps Performed Using a Computer or the Internet

The methods provided herein may include steps performed by the facilitator company using computers and/or internet based communications. For example, the facilitator company may detect an order on a computer from the client for an item of interest (e.g., a research service on a test sample, or at least one of a plurality of functional life science objectives). In certain aspects, the facilitator company provides a selectable internet-based listing of a life science research service or a plurality of functional life science objectives, for example, on a website provided by the facilitator company. Where the facilitator company “provides” a selectable internet-based listing of a life science research service or a plurality of functional life science objectives, it is made available in a computer connected to the internet that is accessible to other computing devices, such as a client computer, connected to the internet.

The client order for the research service may be detected using any appropriate means to detect an order on a computer. The order is typically placed by the client on a first computer connected to the internet. In this case, the facilitator company detects the internet-based order using a second computer also connected to the internet. Thus, the first computer may be a computer that is remote from the second computer (e.g., at different physical sites separated by large distances such as distances greater than 1, 10, 100, or 1000 miles).

The internet consists of a large number of computers connected through network links that communicate using standardized internet protocols to form a global, distributed network. The term “internet,” as used herein refers to the public internet commonly known in the art. Computer users communicate and exchange information over the internet using standardized protocols. The World Wide Web (“WWW”) provides a visual interface to facilitate internet-based communications and exchange of information. The WWW allows a server computer (e.g., a computer used by the facilitator company), having set up a web site, to send text and graphical images in the form of web pages to a client computer for display or storage (e.g., the selectable internet based listings). In some embodiments, the selectable internet based listing is a hyperlink that may be clicked by the client using, for example, any appropriate computer mouse device.

Websites may be assembled using Hyper-Text Markup Language (“HTML”). The software on the client computer that interprets and executes the commands contained in web pages is typically referred to as a browser. A server responds to requests from a computer interfacing the web page (e.g., a computer used by the client). A web page may contain data from a number of different servers. Examples of browsers include the Microsoft Internet Explorer and the Netscape Navigator. The computer interfacing the web page communicates to the browser a desire to view a particular web page by entering that web page's address, which is referred to as its Uniform Resource Locator (“URL”), into the browser. The browser then initiates a client computer request to a server asking that it transfer to the client computer the HTML file that defines the requested web page. When the requested web page is received by the computer interfacing the web page, the browser constructs a visual image of the web page on the interfacing computer's monitor. The web page contains various commands for displaying text, graphics, controls, background colors, and other display features. In addition, the web page may contain other URL addresses (e.g., hyperlinks) that point to other web pages at the server's web site or other web sites.

A browser typically communicates with a web server over a transmission link that operates according to the Transmission Control Protocol/Internet Protocol (“TCP/IP”). For the majority of internet communications, a browser communicating with a server over a TCP/IP link sends and receives information using the Hyper-Text Transfer Protocol (“HTTP”).

Communication between a computer used by the client and the server (e.g., a computer used by the facilitator company) may be facilitated by telephone lines and public network lines that are not inherently secure. Privacy is typically accomplished using cryptographic methods in which communications are encrypted prior to transmission and decrypted subsequent to receipt. A popular protocol for providing an encrypted communication link between the server and the client is the Secure Sockets Layer (“SSL”) protocol developed by Netscape Communications Corp. This protocol is commonly referred to as the HTTPS protocol. A variety of protocols are available, including Private Communications Technology (“PCT”), Secure Hyper-Text Transport Protocol (“SHTTP”), and Pretty Good Privacy (“PGP”), and Secure Sockets Layer (“SSL”) protocol developed by Netscape Communications Corp. Methods for using these and other protocols to provide secure internet connections are well known in the art.

In addition, authentication methods may be used to verify the identity of a given computer entity (e.g., the client computer or the facilitator company computer). One method of authentication uses certificates to authenticate a message. A certificate is a set of digital data that identifies an entity and verifies that the public encryption and signature keys included within the certificate belong to that entity. Methods of providing authentication are well known in the art.

B. Functional Life Science Objectives

In an aspect of the present invention, the facilitator company provides a selectable internet-based listing of a plurality of functional life science objectives, each objective being achieved by performing a plurality of life science research services. At least one of the plurality of life science research services is performed by the life science research service provider. The order is detected on a computer from the client for at least one of the plurality of functional life science objectives. The life science research service provider is notified of the order thereby facilitating the transaction.

In some embodiments, the method also includes receiving a test sample from the client. The facilitator company processes the test sample to form a readily usable test sample for the life science research service provider (as described below). The readily usable test sample is then sent to the life science research service provider.

In certain embodiments, the method may also include receiving data from the life science research service provider for the life science research service. The facilitator company analyzes the data and prepares a report for the client based on the analyses (as described below). The report is then sent to the client.

A functional life science objective refers to a desired assessment goal of a client for a particular test sample requiring the performance of a series of life science research services (e.g., assays) in order to reach the desired assessment goal. The desired assessment goal is related to the life sciences field and answers a functional question regarding the test sample. For example, the sample may be a potential drug. The client may have the assessment goal of determining whether the potential drug is sufficiently non-toxic to file an investigational new drug application (IND) with the Federal Drug Administration (FDA). In this embodiment, the functional life science objective is a preclinical safety study requiring a plurality of assays to assess the safety of the potential drug. Such assays may include, for example, drug-drug interaction assays, cardiotoxicity assays, genotoxicity assays, cell toxicity assays, and target selectivity profiling assays. These safety assays may be performed by one or a plurality of life science research providers, some or all of which may be contacted by the facilitator company in order to fill the client's order.

Because many clients and research providers do not have knowledge of the battery of life science research services required to achieve a functional life science objective, the facilitator company provides valuable knowledge to the client and/or research provider for achieving a given assessment goal of the client. Thus, by identifying particular life science research services required to achieve a requested functional life science objective, and in some embodiments identifying one or more life science research service providers capable of performing one or more of the required life science research services, the facilitator company associates clients with service providers that may otherwise not be associated thereby facilitating transactions between a given client and service provider.

A wide array of life science research objectives may be provided by the facilitator company using the selectable internet-based listing. Appropriate objective include, for example, such as preclinical safety studies, target identification studies, target validation studies, target selectivity profiling studies, drug metabolism studies, biomarker identification studies, chemical optimization studies, drug formulation studies and the like.

Preclinical safety assays include tests designed to evaluate the safety of a potential drug (e.g., a prospective investigational new drug) prior to clinical testing. Preclinical safety studies typically include assays performed with cells and animal models to determine the possible effects of the prospective investigational new drug on the human body in a clinical setting. Target identification studies include tests used to identify one or more molecular or cellular entities that are modulated by a particular chemical or biological test sample (e.g., a prospective drug). Target validation studies include tests designed to confirm or rebut a theory concerning the ability of a chemical or biological sample to modulate one or more molecular or cellular entities. Target selectivity profiling studies include tests to determine whether a particular chemical or biological test sample (e.g., a prospective drug) modulates one or more of a family of related targets (e.g., 10, 100, 500 kinases or all currently known nuclear receptors). Drug metabolism studies include tests to measure the metabolism of a test sample in in vitro assays or in a test animal. Biomarker identification studies include tests to identify surrogate markers for a disease state. Chemical optimization studies include tests to determine optimal chemical synthetic routes for the synthesis of new chemical leads with improved drug properties. Drug formulation studies include tests to identify the optimal salt and crystalline forms of a chemical test sample.

C. Test Samples

In an aspect of the present invention, a method of facilitating a transaction between a client and a life science research service provider is presented. The facilitator company detects an order on a computer from the client for the life science research service provider to provide a research service on a test sample. The test sample is a chemical test sample or a biological test sample. The facilitator company receives the test sample from the client and processes the test sample to form a readily usable test sample for the life science research service provider. The readily usable test sample is sent to the life science research service provider thereby facilitating the transaction. The step of detecting an order on a computer from the client for the life science research service provider to provide a research service on a test sample is described above.

Biological test samples and chemical test samples, as used herein, refer to samples to be tested by the service provider. Biological test samples are those test samples obtained or derived from a biological source, such as cells, tissues, or organisms (e.g., organs, urine liquid, dried blood spot, whole blood, serum, or plasma, hair clippings, skin scrapings etc.). In some embodiments, the biological sample is a cell, tissue, or organ. In other embodiments, the biological test sample is a monoclonal or polyclonal antibody, peptide, small inhibitory RNA (e.g., RNAi), hormone, protein, amino acid, aptamer, cell signaling compound, neurotransmitter, existing or potential drug, lipid, receptor, receptor ligand, oligosaccharide, carbohydrate, cell, virus, bacteria, or nucleic acid.

In other embodiments, the test sample is a mixture of two or more of the previously described test samples. Biological test samples may include one or more analytes for detection in an assay, such as prostate specific antigen, hemoglobin (e.g., a glycolsylated hemoglobin such as hemoglobin Al c), lipids, total cholesterol, HDL cholesterol, LDL cholesterol, triglycerides, homocysteine, CR protein, ALT, calcium, phosphate, acid phosphatase and microalbumin.

The analyte or test sample can also be a microorganism such as a bacterium, e.g., staphylococci, streptococci, neisseria, enterobacteria, vibrionacae, pseudomonas, brucella, yersinia, francisella, haemophilus, bortadella, legionella, bacillus, clostridium, corynbacteria, listeria, mycobacteria, treponema, borrelia, leptospira, mycoplasma, rickettsiae, or chlamydiae. The microorganism may also be a fungus or a virus such as herpes simplex virus (HSV)-1, HSV-2, varicella-zoster, cytomegalovirus, EBV, polyomavirus, papillomavirus, adenoviridae, parvovirus, adeno-associated virus, poxviridae, HIV-1, HIV-2, non-HIV retroviridae, Hepatitis A virus (HAV), Hepatitis B virus (HBV), Hepatitis C virus (HCV), togaviridae, bunyaviridae, polioviruses, coxsackieviruses, echoviruses, rhinoviruses, reoviruses, rotaviruses, orbiviruses, coraonaviridae, influenza A, influenza B, influenza C, paramyxoviridae, rhabodoviridae, or arenaviridae. The analyte might also be a prion such as one associated with bovine spongiform encephalopathy or Creutzfeld-Jacob syndrome, or a protozoum such as a helminth.

Chemical test samples are test samples that are produced synthetically using chemical techniques that have, or are thought to have, a utility in the life science field. Chemical test samples may be a small molecule modulator of a target. Examples of targets include protein kinases, protein phosphatases, cellular receptors (e.g. G-protein coupled receptors (GPCRs)), nuclear receptors, membrane transporters, lipid-modifying enzymes, and cellular structures such as a ribosomes or a proteosome. Chemical test samples include, for example, existing drugs, potential drugs (e.g., a prospective investigational new drug), and may be a small chemical compound (e.g., a chemical compound with a molecular mass under 1,000 daltons), monoclonal or polyclonal antibody, nucleic acid, hormone, protein, carbohydrate, or lipid.

Chemical and biological test samples may also be found in air, water, food, or beverages, for example, as pollutants or adulterants.

The facilitator company receives the test sample from the client and processes the test sample to form a readily usable test sample for the life science research service provider. The test sample is typically sent to the facilitator company from the client using any appropriate means, such as regular U.S. mail, internal pick-up or drop-off services, or a private shipping company. The processing of the test sample is performed by the facilitator company in order to decrease the amount of time or work required by the service provider to perform the service and/or the amount of time or work required by the client to ready the sample for use by the service provider. The particular processing required for the test sample will depend upon the type of test sample and the type of service requested by the client. The processing step may include modification or alteration of the test sample and/or modification or alteration of the test sample environment.

For example, where the test sample is a potential drug, the client may send the potential drug in a solid state (e.g., a powder) requesting that the potential drug be tested in a cellular assay. In order for the service provider to perform the target identification assay on the potential drug, the potential drug must be modified from a solid state to a liquid state using a liquid solvent system compatible with the particular cellular assay performed by the service provider. The solvation of the potential drug is performed by the facilitator company thereby transforming the solid state potential drug into a solvated potential drug that is readily usable by the service provider. By performing these solvation processes on a routine basis, the facilitator company develops expertise resulting in high efficiency and low costs, thereby saving the service provider and/or client time, money, and resources. Thus, the processing performed by the facilitator company increases the convenience and decreases the cost of the transaction between the service provider and client. The client may also send the test sample in a temperature controlled packaging material (e.g. dry ice). The facilitator company ensures the test sample is stored in accordance with temperature restrictions until such time as the research service provider is ready to perform the research service. In some cases, service providers and clients that might not otherwise transact are associated due to the processing steps taken by the facilitator company.

The readily usable test sample is sent to the life science research service provider thereby facilitating the transaction. As with the receiving of the test sample from the client by the facilitator company, the sending of the processed and readily usable test sample from the facilitator company to the service provider may be performed using any appropriate means such as regular U.S. mail, internal drop-off or delivery service, or a private shipping company.

D. Control Samples

In another aspect, a method of facilitating a transaction between a client and a life science research service provider is provided. The method is performed by a single facilitator company and includes providing a selectable internet-based listing of a life science research service. An order is detected on a computer from the client for the life science research service. The facilitator company recommends a control sample based on the order and sends the control sample to the life science research service provider thereby facilitating the transaction. The steps of providing a selectable internet-based listing of a life science research service and detecting an order on a computer are described above.

In some embodiments, the method also includes receiving a test sample from the client. The test sample is processed to form a readily usable test sample for the life science research service provider (as described above). The readily usable test sample is then sent to the life science research service provider.

In certain embodiments, the method may also include receiving data from the life science research service provider for the life science research service. The facilitator company analyzes the data and prepares a report for the client based on the analysis (as described below). The report is then sent to the client.

The facilitator company recommends a control sample based on the order and sends the control sample to the life science research service provider thereby facilitating the transaction. The purpose of the facilitator company recommending a control sample is to provide a service to the client and/or service provider based on the facilitator company's legal and/or scientific knowledge of control samples that are available for public use that provide useful standards for comparison for any test sample being tested in the life science research service ordered by the client. Thus, neither the client nor the service provider is required to develop expertise or consult outside parties to determine standards of comparison for a given life science research service. Thus, the facilitator company facilitates a transaction between the service provider and client by increasing convenience and scientific value of the research service transaction.

For example, where the life science research service ordered by the client is an in vitro molecular binding assay against a particular cell receptor, the facilitator company will recommend one or more known cell receptor binders as control samples. One ore more of the known cell receptor binders may be existing, proprietary, and/or marketed drugs. Based on the scientific and legal knowledge of the facilitator company, the facilitator can recommend the marketed drug for use as a control sample.

The control sample is typically a bioactive control sample. A bioactive control sample is a control sample having biological activity. In some embodiments, the control sample is a known drug, a marketed drug, a known clinical drug candidate, a failed drug (e.g. that was rejected by the FDA), or a chemical with certain known biological activities. For example, control samples for a Heat Shock Protein 90 (HSP90) assay may include geldanamycin, a known HSP90 inhibitor, or 17-AAG, a known HSP90 inhibitor and clinical drug candidate.

In some embodiments, the control sample is sent to the service provider as a readily usable control sample (i.e., a control sample in a format that is ready to be used by the service provider in the particular life science research service). By having access to and routinely using particular control samples, the facilitator company can provide the control samples with high speed and low cost.

E. Analyzing Data for the Client

In another aspect, a method of facilitating a transaction between a client and a life science research service provider is presented. The method is performed by a single facilitator company and includes detecting an order on a computer from the client for the life science research service provider to provide a research service on a test sample. The test sample is a chemical test sample or a biological test sample. The facilitator company receives data from the life science research service provider for the life science research service on the test sample. The data is analyzed and a report is prepared for the client based on the analysis. The response is sent to the client thereby facilitating the transaction. The steps of detecting an order are described above. The method may also include the step of notifying the life science research service provider of the order.

In some embodiments, the method also includes receiving a test sample from the client. The facilitator company processes the test sample to form a readily usable test sample for the life science research service provider (as described above). The readily usable test sample is then sent to the life science research service provider.

In some embodiments, the data received by the facilitator company is analyzed according to scientific standard known in the life sciences field. For example, the facilitator company analyzes the data according to accepted error standards and/or data quality standards known in the life science field. In certain embodiments, the facilitator company analyzes the data according to accepted error standards and/or data quality standards agreed upon by the facilitator company and the client and/or the service provider. Because the facilitator company routinely provides data analysis, the facilitator company may possess superior equipment (e.g., computational power) and/or data analysis expertise relative to the client or service provider. Thus, by filling the knowledge or capability gap between the client and service provider, the facilitator company facilitates the transaction between the client and service provider.

The facilitator company receives data from the life science research service provider for the research service on the test sample using any appropriate means of transport (e.g., U.S. mail, drop-off service, private carriers, computers, or the internet). Likewise, the report may be sent to the client using any appropriate means. For example, after a sample has been analyzed at the service provider, a computer communications network can be used to report the data (i.e., test results) to the facilitator company or send the report to the client. A computer communications network includes a computer communications network access device (e.g., a computer connected to the internet), a computer communications network (e.g., the Internet, a LAN, or a WAN), and a server. The data or report can be provided through a graphical user interface (GUI) to a database wherein each graphical field in the GUI can map to a field in a record in the database. The design and implementation of a GUI to a database is well known and may be performed without specific knowledge of computer programming using publicly available rapid application development tools.

In certain embodiments, the data and/or report can be stored in a record in a database. The definition, creation and population of a database is well known, and can be performed without specific knowledge of database administration using such database tools as Microsoft Access, Powersoft Powerbuilder or Oracle 8i. Thus, the data and/or report can be stored using any suitable means, for example, by streaming the results into a text file. The database can be accessed by a remote user across the internet using nothing more than a web browser. More particularly, a data access website can be provided by the facilitator company's server to the client and/or service provider in which data and/or the report can be supplied or accessed. For example, the server having access to the database is provided through which HTTP requests for data can be translated to a query of the database. The server can contain server-side scripts which can be used to provide database queries to external databases. Additionally, the server-side scripts can be used to provide server-side functionality.

Where the user's identity is authenticated, a database query can be formed based on the data provided by the user in the request webpage. The database query can be any suitable query operable to access the database and retrieve a result set of records consonant with the query. The query may be a structured query language (SQL) query which can be used to retrieve result sets from most contemporary databases. The database query can be implemented in a server-side script and transmitted to a database interface. Typically, the manipulation of records in a database can be performed through an interface, for example an Open Database Connectivity (ODBC) interface. Any suitable database interface will suffice.

The terms and expressions which have been employed herein are used as terms of description and not of limitation, and there is no intention in the use of such terms and expressions of excluding equivalents of the features shown and described, or portions thereof, it being recognized that various modifications are possible within the scope of the invention claimed. Moreover, any one or more features of any embodiment of the invention may be combined with any one or more other features of any other embodiment of the invention, without departing from the scope of the invention.

### III. EXAMPLES

The following examples are intended to illustrate certain embodiments of the present invention, and not to limit the scope of the invention disclosed herein.

### Example 1

A small biotechnology company client plans to file an investigational new drug (IND) application with the FDA for a chemical drug candidate in development for the past two years. To increase the probability of FDA approval of the IND application, it is necessary to provide the FDA with laboratory data demonstrating that its drug candidate is inactive in biological assays for human toxicity, including assays for cardiotoxicity, genotoxicity, cytotoxicity, and drug-drug interaction. Carrying out this set of human toxicity assays within the client's laboratory is not possible because it would require substantial investment in new research technologies as well as access to specialized drug discovery expertise not possessed by the client. The client therefore must outsource the testing of its drug candidate to one or more specialized service companies that offer toxicity testing services.

While simple in concept, outsourcing these assays to specialized service providers is challenging for the client. First, there are many potential providers of the specialized testing services that are required, and each must be contacted and evaluated individually. Second, different service companies offer testing services that are similar but not identical and the Client lacks sufficient internal expertise to choose the exact set of services that are needed. Third, it is difficult and time-consuming for the client to manage relationships with multiple research service providers, as each requires separate price negotiation, separate service agreements, separate test sample shipping procedures and separate data reporting methods.

By acting as an intermediary between the client and a diverse set of research service providers, the facilitator company facilitates the transaction in three ways. First, the facilitator company rigorously pre-evaluates service providers and only engages for the client those service providers that offer high quality research services. Second, the facilitator company employs highly experienced drug discovery specialists that group together services from different service providers in a manner that makes is easy for the client to choose the appropriate set of services without having significant internal drug discovery expertise. Third, the facilitator company is a single point of contact between the client and a diverse set of service providers. This greatly simplifies logistics around price negotiation, service agreements, test sample shipping and data reporting.

The client visits the facilitator company website on the Internet, where it is possible to select from a number of expert pre-selected panels of toxicity testing services. In this example, the client chooses a pre-selected set of services that include testing for cardiotoxicity, genotoxicity, cytotoxicity and drug-drug interaction. Although each of these services is carried out by a different service provider, it is only necessary for the client to place one order and transfer one test sample to the facilitator company.

Once an order has been detected on the facilitator company website, the facilitator company notifies each service provider that an order has been placed. The facilitator company processes the test sample to form a readily usable test sample for the service providers, and sends it to the appropriate service providers. Each of the service providers then carries out at least one research service. For example, service provider A analyzes the effect of the test sample on activity of the HERG ion channel, a known surrogate for cardiotoxic effects. Service provider B determines whether the test sample is mutagenic in an Ames test, a known surrogate for genotoxic effects. Service provider C analyzes the effect of the test sample on cellular mitochondrial function, a known surrogate for human cell toxicity. Service provider D analyzes the effect of the test sample on activity of multiple cytochrome P450 isoforms, which are known to be responsible for drug-drug interaction liabilities.

The facilitator company receives a single data report from each service provider that contains results from the analysis of the client's test sample. The facilitator company processes the data from each service provider, prepares a single data report containing results from all four services, and sends a single data report to each client.

### Example 2

The client is a small pharmaceutical company that has identified a new drug candidate with inhibitory activity against the B-Raf kinase, a cancer drug target. The client wants to compare the activity of their new drug candidate to the activity of other B-Raf benchmark (i.e. control) inhibitors that; 1. have already been approved by the FDA; 2. are currently in human clinical trials; and 3. are used most frequently by the research community. Carrying out this comparison within the client's laboratory is not possible because it would require specialized expertise and technology not possessed by the client.

The client visits the facilitator company website on the Internet and chooses a service provider that offers a B-Raf activity assay by clicking on the appropriate hyperlink. Once the facilitator company detects that an order for B-Raf assay is being considered by the client, it accesses a database of known B-Raf inhibitors and displays the results to the client on the website. The client then selects which, if any, B-Raf inhibitor to include as part of its order. For example, the client may choose to include in its order the marketed drug Nexavar® (a known B-Raf inhibitor), the clinical candidate CHIR-265 (a known B-Raf inhibitor) and GW5074, a B-Raf inhibitor that is often used by the research community. All of these benchmark samples are supplied by the facilitator company. The client simply transfers their B-Raf drug candidate to the facilitator company, which processes the compound and sends it together with any ordered B-Raf benchmark compounds to the service provider.

The facilitator company receives a data report from the service provider that contains results from the analysis of the client's test sample and the various benchmark samples ordered by the client from the facilitator company. The facilitator company analyzes the data from the service provider, prepares a single data report containing results from the test sample and the three benchmark samples, and sends the data report to the client.

What is claimed is:

1. A method of facilitating a transaction between a client and a life science research service provider wherein said method is performed by a single facilitator company, said method comprising the steps of:
(1) detecting an order on a computer from said client for said life science research service provider to provide a research service on a test sample, wherein said test sample is a chemical test sample or a biological test sample;
(2) receiving said test sample from said client;
(3) processing said test sample to form a readily usable test sample for said life science research service provider; and
(4) sending said readily usable test sample to said life science research service provider thereby facilitating said transaction.

2. The method of claim 1, wherein said client is a for-profit company client or non-profit institutional client.

3. The method of claim 2, wherein said for-profit company client is a pharmaceutical company, a diagnostic company, a cosmetics company, a neutraceutical company, an environmental analysis company, a virtual drug discovery company, or a biotechnology company.

4. The method of claim 2, wherein said non-profit institutional client is an academic client.

5. The method of claim 1, wherein said life science research service provider is a for-profit life science research service provider company or non-profit institutional life science research service provider.

6. The method of claim 5, wherein said for-profit life science research service provider is a pharmaceutical company, a diagnostics company, an assay reagent company, an assay technology company or a biotechnology company.

7. The method of claim 5, wherein said non-profit institutional life science research service provider is an academic life science research service provider.

8. The method of claim 1, wherein said test sample is a small molecule modulator, a protein, an aptamer, or a nucleic acid.

9. The method of claim 1, wherein said test sample is a prospective investigational new drug.

10. The method of claim 1, wherein said life science research service provider is a corporate life science research service provider or non-profit institutional life science research service provider.

11. The method of claim 1, wherein said life science research service provider is a pharmaceutical company.

12. A method of facilitating a transaction between a client and a life science research service provider, wherein said method is performed by a single facilitator company, said method comprising the steps of:
(1) providing a selectable internet-based listing of a life science research service;
(2) detecting an order on a computer from said client for said life science research service;
(3) recommending a control sample based on said order; and
(4) sending said control sample to said life science research service provider thereby facilitating said transaction.

13. The method of claim 12 further comprising the steps of:
(i) receiving a test sample from said client;
(ii) processing said test sample to form a readily usable test sample for said life science research service provider; and
(iii) sending said readily usable test sample to said life science research service provider.

14. The method of claim 12, further comprising the steps of:
(a) receiving data from said life science research service provider for said life science research service;
(b) analyzing said data and preparing a report for said client based on said analyzing; and
(c) sending said report to said client.

15. The method of claim 12, wherein said life science research service is an life science research service is an in vitro molecular interaction assay, a cellular assay, a molecular property assay, a pharmacokinetic assay, a toxicology assay, a pharmacology assay, or a chemistry service.

16. The method of claim 12, wherein said control sample is a bioactive control sample.

17. The method of claim 12, wherein said control sample is a known drug, or a known clinical drug candidate.

18. A method of facilitating a transaction between a client and a life science research service provider, wherein said method is performed by a single facilitator company, said method comprising the steps of:
(1) providing a selectable internet-based listing of a plurality of functional life science objectives, each objective being achieved by performing a plurality of life science research services, wherein at least one of said plurality of life science research services is performed by said life science research service provider;
(2) detecting an order on a computer from said client for at least one of said plurality of functional life science objectives; and
(3) notifying said life science research service provider of said order thereby facilitating said transaction.

19. The method of claim 18 further comprising the steps of:
(i) receiving a test sample from said client;
(ii) processing said test sample to form a readily usable test sample for said life science research service provider; and
(iii) sending said readily usable test sample to said life science research service provider.

20. The method of claim 18 further comprising the steps of:
(a) receiving data from said life science research service provider for said life science research service;
(b) analyzing said data and preparing a report for said client based on said analyzing; and
(c) sending said report to said client.

21. The method of claim 18, wherein said life science research objective is a preclinical safety study, a target identification study, a target validation study, a target selectivity profiling study, a drug metabolism study, a biomarker identification study, a chemical optimization study, or a drug formulation studies.

22. A method of facilitating a transaction between a client and a life science research service provider, wherein said method is performed by a single facilitator company, said method comprising the steps of:
(1) detecting an order on a computer from said client for said life science research service provider to provide a research service on a test sample, wherein said test sample is a chemical test sample or a biological test sample;
(2) notifying said life science research service provider of said order;
(3) receiving data from said life science research service provider for said life science research service on said test sample;
(4) analyzing said data and preparing a report for said client based on said analyzing; and
(5) sending said report to said client thereby facilitating said transaction.

23. The method of claim 22 further comprising the step of notifying said life science research service provider of said order.

24. The method of claim 22 further comprising the steps of:
(i) receiving said test sample from said client;
(ii) processing said test sample to form a readily usable test sample for said life science research service provider; and
(iii) sending said readily usable test sample to said life science research service provider.
